(19) United States
(12) Patent Application Publication
(10) Pub. No.: US 2009/0177393 A1
(43) Pub. Date: Jul. 9, 2009

(54) Navigation device and method

(76) Inventors: Simone Francine Tertoolen, Amsterdam (NL); Jasper Michiel van Hemert, Utrecht (NL)

Correspondence Address: TOMTOM INTERNATIONAL B.V., REMBRANDTPLEIN 35, AMSTERDAM, 1017CT, NL

(21) Appl. No.: 12/007,136

(22) Filed: Jan. 7, 2008

(51) Int. Cl. G01C 21/20

(52) U.S. Cl. 701/212; 701/220

(57) ABSTRACT

A method of displaying enhanced map information on a PND, and a PND capable of displaying such enhanced information is described. In accordance with the invention, the PND determines its velocity and displays map information on a display screen thereof. The map information is continually and/or periodically refreshed to take account of the displacement of the device brought about by its velocity. The invention is characterized in that the extent to which the map information displayed is enhanced to include one or more enhanced features is dependent to some degree on the velocity of the PND, said enhanced features being chosen from the group containing: building textures, digitized photographic images of building facades, landscapes, discrete areas of land and buildings, vistas, patterns representative of land use, street lights, electricity pylons, tram rails, train rails, zebra crossings and traffic signs, types of road surfaces or patterns indicative thereof, road markings, traffic lights, landmarks in the distance or digitized photographs thereof, cities in the distance or digitized photographs thereof, animated patterns, bicycle lanes, bus lanes, graphically or textually represented commercial, agricultural, tourist or traffic information, and enhanced POI icons.

### BACKGROUND OF THE INVENTION

Portable navigation devices (PNDS) including GPS (Global Positioning System) signal reception and processing means are well known and are widely employed as in-car navigation systems. In essence, modern PNDs comprise:
a processor,
memory (at least one of volatile and non-volatile, and commonly both),
map data stored within said memory,
a software operating system and optionally one or more additional programs executing thereon, to control the functionality of the device and provide various features,
a GPS antenna by which satellite-broadcast signals including location data can be received and subsequently processed to determine a current location of the device,
optionally, electronic gyroscopes and accelerometers which produce signals capable of being processed to determine the current angular and linear acceleration, and in turn, and in conjunction with location information derived from the GPS signal, velocity and relative displacement of the device and thus the vehicle in which it is mounted,
input and output means, examples including a visual display (which may be touch sensitive to allow for user input), one or more physical buttons to control on/off operation or other features of the device, a speaker for audible output,
optionally one or more physical connectors by means of which power and optionally one or more data signals can be transmitted to and received from the device, and
optionally one or more wireless transmitters/receivers to allow communication over mobile telecommunications and other signal and data networks, for example Wi-Fi, Wi-Max GSM and the like.

The utility of the PND is manifested primarily in its ability to determine a route between a start or current location and a destination, which can be input by a user of the computing device, by any of a wide variety of different methods, for example by postcode, street name and number, and previously stored well known, favourite or recently visited destinations. Typically, the PND is enabled by software for computing a “best” or “optimum” route between the start and destination address locations from the map data. A “best” or “optimum” route is determined on the basis of predetermined criteria and need not necessarily be the fastest or shortest route. The selection of the route along which to guide the driver can be very sophisticated, and the selected route may take into account existing and predicted traffic and road conditions, historical information about road speeds, and the driver's own preferences for the factors determining road choice. In addition, the device may continually monitor road and traffic conditions, and offer to or choose to change the route over which the remainder of the journey is to be made due to changed conditions. Real time traffic monitoring systems, based on various technologies (e.g. mobile phone calls, fixed cameras, GPS fleet tracking) are being used to identify traffic delays and to feed the information into notification systems.

The navigation device may typically be mounted on the dashboard of a vehicle, but may also be formed as part of an on-board computer of the vehicle or car radio. The navigation device may also be (part of) a hand-held system, such as a PDA (Personal Navigation Device) a media player, a mobile phone or the like, and in these cases, the normal functionality of the hand-held system is extended by means of the installation of software on the device to perform both route calculation and navigation along a calculated route. In any event, once a route has been calculated, the user interacts with the navigation device to select the desired calculated route, optionally from a list of proposed routes. Optionally, the user may intervene in, or guide the route selection process, for example by specifying that certain routes, roads, locations or criteria are to be avoided or are mandatory for a particular journey. The route calculation aspect of the PND forms one primary function provided, and the navigation along such a route is another primary function. During navigation along a calculated route, the PND provides visual and/or audible instructions to guide the user along a chosen route to the end of that route, that is the desired destination. It is usual for PNDs to display map information on-screen during the navigation, such information regularly being updated on-screen so that the map information displayed is representative of the current location of the device, and thus of the user or user's vehicle if the device is being used for in-car navigation. An icon displayed on-screen typically denotes the current device location, and is centred with the map information of current and surrounding roads and other map features being also displayed. Additionally, navigation information may be displayed, optionally in a status bar above, below or to one side of the displayed map information, examples of navigation information including the distance to the next deviation from the current road required to be taken by the user, the nature of that deviation possibly being represented by a further icon suggestive of the particular type of deviation, for example a left or right turn. The navigation function also determines the content, duration and timing of audible instructions by means of which the user can be guided along the route. As can be appreciated a simple instruction such as “turn left in 100 m” requires significant processing and analysis. As previously mentioned, user interaction with the device may be by a touch screen, or additionally or alternately by steering column mounted remote control, by voice activation or by any other suitable method.

A further important function provided by the device is automatic route re-calculation in the event that
a user deviates from the previously calculated route during navigation therealong,
real-time traffic conditions dictate that an alternative route would be more expedient and the device is suitably enabled to recognize such conditions automatically, or
if a user actively causes the device to perform route re-calculation for any reason.

It is also known to allow a route to be calculated with user defined criteria; for example, the user may prefer a scenic route to be calculated by the device. The device software would then calculate various routes and weigh more favourably those that include along their route the highest number of points of interest (known as POIs) tagged as being for example of scenic beauty. Other POI-based route calculation and navigation criteria are also possible.

Although the route calculation and navigation functions are fundamental to the overall utility of PNDs, it is possible to use the device purely for information display, or “free-driving”, in which only map information relevant to the current device location is displayed, and in which no route has been calculated and no navigation is currently being performed by the device. Such a mode of operation is often applicable when the user already knows the route along which it is desired to travel and does not require navigation assistance.

Currently, the map information displayed during navigation or in a free driving mode of operation of the device is quite limited, and generally restricted to only basic road demarcations, bridges, and other basic iconic and colour graphic representations of points of interest (POIs), traffic congestion, text-based street names, and basic indications of land use, for example built-up areas and open land free of construction.

In many cases, the digital map information which is available from providers only includes this basic information, but more recently, enhanced map information for certain countries, or cities within such countries, has become available. In such enhanced map information, a wide variety of additional digitized information is included, examples including building textures, digitized photographic images of building facades, patterns representative of land use, street lights, electricity pylons, tram rails, train rails, zebra crossings and traffic signs, types of road surfaces, road markings, traffic lights, landmarks in the distance, cities in the distance, animated patterns (e.g. waves for water), bicycle lanes, bus lanes, extra (e.g. commercial, agricultural, tourist) information (e.g. rich content in HTML or other form) about POIs or the locality, enhanced POI icons, traffic information, detailed shadows, weather information.

As will be appreciated, map information is being continually improved by map information providers, but when traveling at speed, there are good reasons why it is preferable to display only limited map information. Firstly, as will be appreciated from the extent of additional information becoming available and listed above, and having regard to the limited processing power, memory and display capability of modern PNDs, it is very difficult to achieve a seamless transition between frames of displayed map information when so much additional information is included in the map data, especially in cities. The PND simply cannot process the map data for display quickly enough. Secondly, the display of so much information on the display screen of the device can be very distracting to user while driving, and therefore a basic informational display is preferred. Finally, regardless of whether enhanced map information is displayed on the device, the user, if traveling at any significant speed, has little time to take in the local surroundings in any event, and therefore the benefit of displaying such enhanced information is marginal.

Known PNDs include one or more options to allow the user to select which specific features within the enhanced map information are available for display. However, again, the changing of the options on a PND during motion, particularly at any speed, can be dangerous and is unavoidably highly distracting to the user.

It would however be advantageous to a user of the device, particularly when traveling relatively slowly through any locality not familiar to the user, to display as much of the enhanced map information as is practical to assist in the user's orientation in that locality.

It is an object of this invention to provide a method and PND which is adapted to display enhanced map information in a useful manner and thus overcome the described disadvantages.

### BRIEF SUMMARY OF THE INVENTION

According to the present invention there is provided a method of displaying enhanced map information on a PND comprising the steps of

Determining the velocity of the PND, and

Displaying map information on a display screen of the PND, said map information being continually and/or periodically refreshed to take account of the displacement of the device brought about by its velocity,

Characterized in that

The extent to which the map information displayed is enhanced to include one or more enhanced features is dependent to some degree on the velocity of the PND, said enhanced features being chosen from the group containing:

building textures,

digitized photographic images of building facades, landscapes, discrete areas of land and buildings, vistas,

patterns representative of land use,

street lights,

electricity pylons,

tram rails, train rails,

zebra crossings and traffic signs,

types of road surfaces or patterns indicative thereof,

road markings,

traffic lights,

landmarks in the distance or digitized photographs thereof,

cities in the distance or digitized photographs thereof,

animated pattern,

bicycle lanes,

bus lanes,

graphically or textually represented commercial, agricultural, tourist or traffic information, and

enhanced POI icons.

In a preferred embodiment, the method is further specified by providing graded enhancement of the map information displayed, or one particular feature included in the enhanced map information, in dependence on the device velocity, so as to vary the level of detail displayed on the screen of the device between one or more threshold velocities.

Most preferably, the map information displayed, or one or more of the features included as part of the enhanced map information, is fully enhanced when the device velocity is below a first low threshold, the map information displayed, or one or more of the features included as part of the enhanced map information, is partially enhanced when the device velocity is between a first low threshold and a second intermediate threshold, said map information, or one or more of the features included as part of the enhanced map information, being enhanced to a lesser or minimal degree, or not enhanced at all, when the device velocity is above a third high threshold.

In further aspects of the invention, a computer program is provided for implementing the methods described above, as is a PND and/or navigation system adapted to perform the methods described.

### BRIEF DESCRIPTION OF THE SEVERAL VIEWS OF THE INVENTION

The present application will be described in more detail below by using example embodiments, which will be explained with the aid of the drawings, in which:

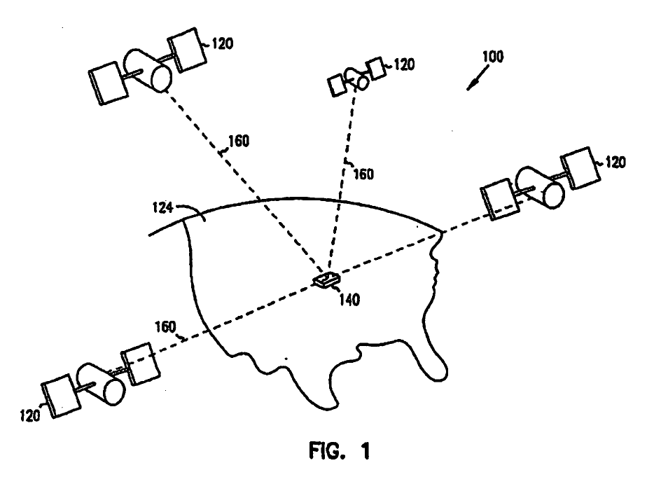

FIG. 1 illustrates an example view of a Global Positioning System (GPS);

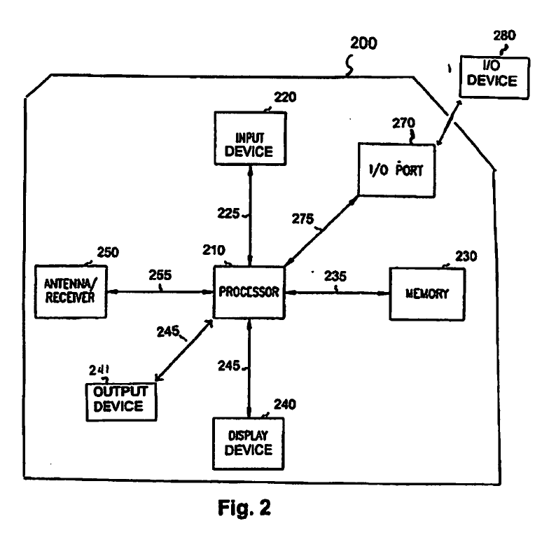

FIG. 2 illustrates an example block diagram of electronic components of a navigation device;

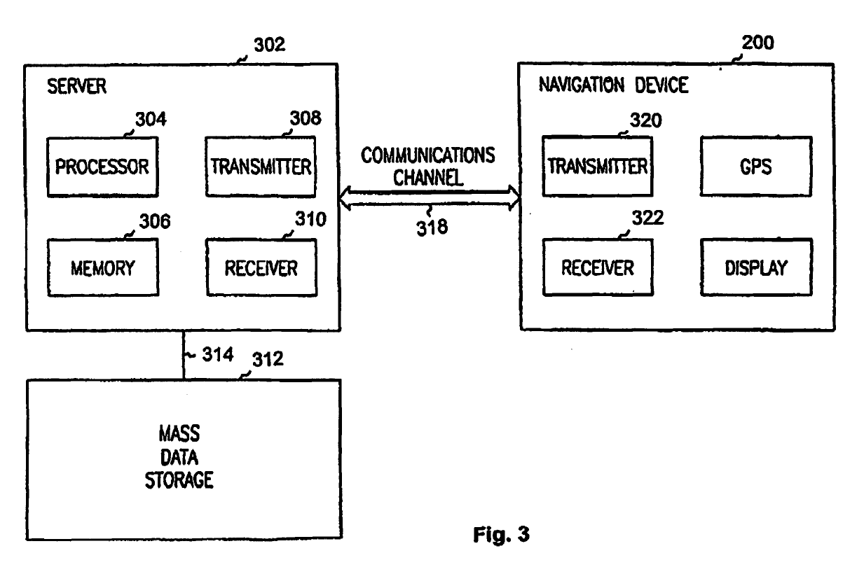

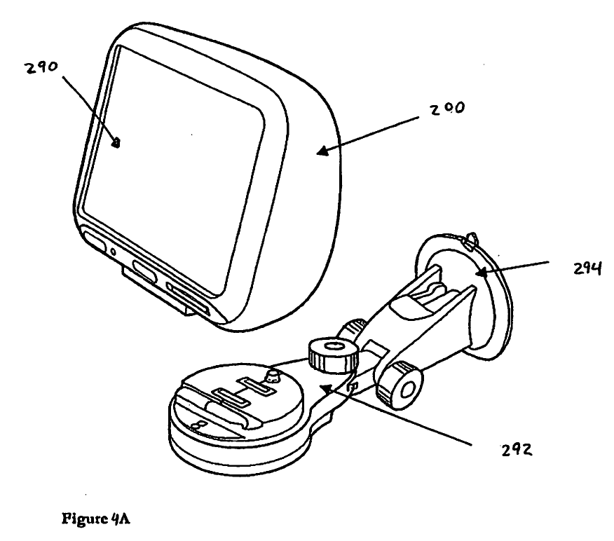

FIG. 3 illustrates an example block diagram of the manner in which a navigation device may receive information over a wireless communication channel;

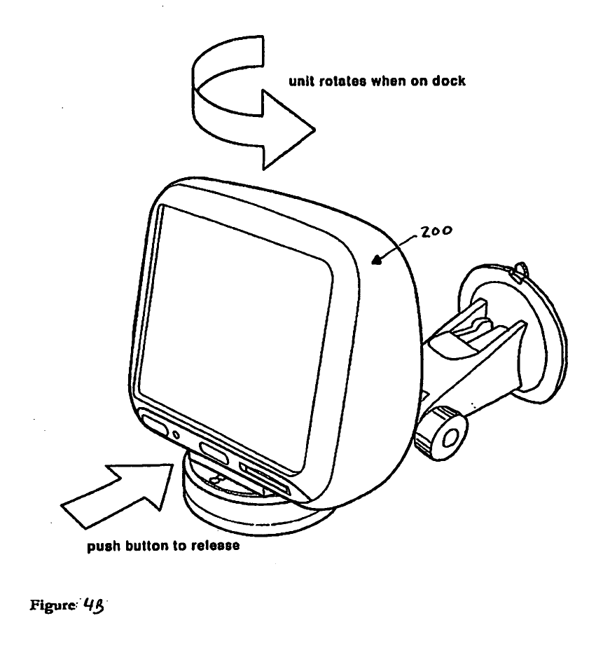

FIGS. 4A and 4B are perspective views of an implementation of an embodiment of the navigation device;

### DETAILED DESCRIPTION OF THE INVENTION

FIG. 1 illustrates an example view of Global Positioning System (GPS), usable by navigation devices. Such systems are known and are used for a variety of purposes. In general, GPS is a satellite-radio based navigation system capable of determining continuous position, velocity, time, and in some instances direction information for an unlimited number of users.

Formerly known as NAVSTAR, the GPS incorporates a plurality of satellites which work with the earth in extremely precise orbits. Based on these precise orbits, GPS satellites can relay their location to any number of receiving units.

The GPS system is implemented when a device, specially equipped to receive GPS data, begins scanning radio frequencies for GPS satellite signals. Upon receiving a radio signal from a GPS satellite, the device determines the precise location of that satellite via one of a plurality of different conventional methods. The device will continue scanning, in most instances, for signals until it has acquired at least three different satellite signals (noting that position is not normally, but can be determined, with only two signals using other triangulation techniques). Implementing geometric triangulation, the receiver utilizes the three known positions to determine its own two-dimensional position relative to the satellites. This can be done in a known manner. Additionally, acquiring a fourth satellite signal will allow the receiving device to calculate its three dimensional position by the same geometrical calculation in a known manner. The position and velocity data can be updated in real time on a continuous basis by an unlimited number of users.

As shown in FIG. 1, the GPS system is denoted generally by reference numeral 100. A plurality of satellites 120 are in orbit about the earth 124. The orbit of each satellite 120 is not necessarily synchronous with the orbits of other satellites 120 and, in fact, is likely asynchronous. A GPS receiver 140 is shown receiving spread spectrum GPS satellite signals 160 from the various satellites 120.

The spread spectrum signals 160, continuously transmitted from each satellite 120, utilize a highly accurate frequency standard accomplished with an extremely accurate atomic clock. Each satellite 120, as part of its data signal transmission 160, transmits a data stream indicative of that particular satellite 120. It is appreciated by those skilled in the relevant art that the GPS receiver device 140 generally acquires spread spectrum GPS satellite signals 160 from at least three satellites 120 for the GPS receiver device 140 to calculate its two-dimensional position by triangulation. Acquisition of an additional signal, resulting in signals 160 from a total of four satellites 120, permits the GPS receiver device 140 to calculate its three-dimensional position in a known manner. FIG. 2 illustrates an example block diagram of electronic components of a navigation device 200, in block component format. It should be noted that the block diagram of the navigation device 200 is not inclusive of all components of the navigation device, but is only representative of many example components.

The navigation device 200 is located within a housing (not shown). The housing includes a processor 210 connected to an input device 220 and a display screen 240. The input device 220 can include a keyboard device, voice input device, touch panel and/or any other known input device utilized to input information; and the display screen 240 can include any type of display screen such as an LCD display, for example. The input device 220 and display screen 240 are integrated into an integrated input and display device, including a touchpad or touchscreen input wherein a user need only touch a portion of the display screen 240 to select one of a plurality of display choices or to activate one of a plurality of virtual buttons.

In addition, other types of output devices 250 can also include, including but not limited to, an audible output device. As output device 241 can produce audible information to a user of the navigation device 200, it is equally understood that input device 240 can also include a microphone and software for receiving input voice commands as well. In the navigation device 200, processor 210 is operatively connected to and set to receive input information from input device 240 via a connection 225, and operatively connected to at least one of display screen 240 and output device 241, via output connections 245, to output information thereto. Further, the processor 210 is operatively connected to memory 230 via connection 235 and is further adapted to receive/send information from/to input/output (I/O) ports 270 via connection 275, wherein the I/O port 270 is connectible to an I/O device 280 external to the navigation device 200. The external I/0 device 270 may include, but is not limited to an external listening device such as an earpiece for example. The connection to I/0 device 280 can further be a wired or wireless connection to any other external device such as a car stereo unit for hands-free operation and/or for voice activated operation for example, for connection to an ear piece or head phones, and/or for connection to a mobile phone for example, wherein the mobile phone connection may be used to establish a data connection between the navigation device 200 and the internet or any other network for example, and/or to establish a connection to a server via the internet or some other network for example.

The navigation device 200 may establish a “mobile” or telecommunications network connection with the server 302 via a mobile device 400 (such as a mobile phone, PDA, and/or any device with mobile phone technology) establishing a digital connection (such as a digital connection via known Bluetooth technology for example). Thereafter, through its network service provider, the mobile device 400 can establish a network connection (through the internet for example) with a server 302. As such, a “mobile” network connection is established between the navigation device 200 (which can be, and often times is mobile as it travels alone and/or in a vehicle) and the server 302 to provide a “real-time” or at least very “up to date” gateway for information.

The establishing of the network connection between the mobile device 400 (via a service provider) and another device such as the server 302, using the internet 410 for example, can be done in a known manner. This can include use of TCP/IP layered protocol for example. The mobile device 400 can utilize any number of communication standards such as CDMA, GSM, WAN, etc.

As such, an internet connection may be utilized which is achieved via data connection, via a mobile phone or mobile phone technology within the navigation device 200 for example. For this connection, an internet connection between the server 302 and the navigation device 200 is established. This can be done, for example, through a mobile phone or other mobile device and a GPRS (General Packet Radio Service)-connection (GPRS connection is a high-speed data connection for mobile devices provided by telecom operators; GPRS is a method to connect to the internet.

The navigation device 200 can further complete a data connection with the mobile device 400, and eventually with the internet 410 and server 302, via existing Bluetooth technology for example, in a known manner, wherein the data protocol can utilize any number of standards, such as the GSRM, the Data Protocol Standard for the GSM standard, for example.

The navigation device 200 may include its own mobile phone technology within the navigation device 200 itself (including an antenna for example, wherein the internal antenna of the navigation device 200 can further alternatively be used). The mobile phone technology within the navigation device 200 can include internal components as specified above, and/or can include an insertable card (e.g. Subscriber Identity Module or SIM card), complete with necessary mobile phone technology and/or an antenna for example. As such, mobile phone technology within the navigation device 200 can similarly establish a network connection between the navigation device 200 and the server 302, via the internet 410 for example, in a manner similar to that of any mobile device 400.

For GRPS phone settings, the Bluetooth enabled device may be used to correctly work with the ever changing spectrum of mobile phone models, manufacturers, etc., model/manufacturer specific settings may be stored on the navigation device 200 for example. The data stored for this information can be updated.

FIG. 2 further illustrates an operative connection between the processor 210 and an antenna/receiver 250 via connection 255, wherein the antenna/receiver 250 can be a GPS antenna/receiver for example. It will be understood that the antenna and receiver designated by reference numeral 250 are combined schematically for illustration, but that the antenna and receiver may be separately located components, and that the antenna may be a GPS patch antenna or helical antenna for example.

Further, it will be understood by one of ordinary skill in the art that the electronic components shown in FIG. 2 are powered by power sources (not shown) in a conventional manner. As will be understood by one of ordinary skill in the art, different configurations of the components shown in FIG. 2 are considered within the scope of the present application. For example, the components shown in FIG. 2 may be in communication with one another via wired and/or wireless connections and the like. Thus, the scope of the navigation device 200 of the present application includes a portable or handheld navigation device 200.

In addition, the portable or handheld navigation device 200 of FIG. 2 can be connected or “docked” in a known manner to a motorized vehicle such as a car or boat for example. Such a navigation device 200 is then removable from the docked location for portable or handheld navigation use.

FIG. 3 illustrates an example block diagram of a server 302 and a navigation device 200 capable of communicating via a generic communications channel 318. The server 302 and a navigation device 200 can communicate when a connection via communications channel 318 is established between the server 302 and the navigation device 200 (noting that such a connection can be a data connection via mobile device, a direct connection via personal computer via the internet, etc.).

The server 302 includes, in addition to other components which may not be illustrated, a processor 304 operatively connected to a memory 306 and further operatively connected, via a wired or wireless connection 314, to a mass data storage device 312. The processor 304 is further operatively connected to transmitter 308 and receiver 310, to transmit and send information to and from navigation device 200 via communications channel 318. The signals sent and received may include data, communication, and/or other propagated signals. The transmitter 308 and receiver 310 may be selected or designed according to the communications requirement and communication technology used in the communication design for the navigation system 200. Further, it should be noted that the functions of transmitter 308 and receiver 310 may be combined into a signal transceiver. Server 302 is further connected to (or includes) a mass storage device 312, noting that the mass storage device 312 may be coupled to the server 302 via communication link 314. The mass storage device 312 contains a store of navigation data and map information, and can again be a separate device from the server 302 or can be incorporated into the server 302.

The navigation device 200 is adapted to communicate with the server 302 through communications channel 318, and includes processor, memory, etc. as previously described with regard to FIG. 2, as well as transmitter 320 and receiver 322 to send and receive signals and/or data through the communications channel 318, noting that these devices can further be used to communicate with devices other than server 302. Further, the transmitter 320 and receiver 322 are selected or designed according to communication requirements and communication technology used in the communication design for the navigation device 200 and the functions of the transmitter 320 and receiver 322 may be combined into a single transceiver.

Software stored in server memory 306 provides instructions for the processor 304 and allows the server 302 to provide services to the navigation device 200. One service provided by the server 302 involves processing requests from the navigation device 200 and transmitting navigation data from the mass data storage 312 to the navigation device 200. Another service provided by the server 302 includes processing the navigation data using various algorithms for a desired application and sending the results of these calculations to the navigation device 200.

The communication channel 318 generically represents the propagating medium or path that connects the navigation device 200 and the server 302. Both the server 302 and navigation device 200 include a transmitter for transmitting data through the communication channel and a receiver for receiving data that has been transmitted through the communication channel.

The communication channel 318 is not limited to a particular communication technology. Additionally, the communication channel 318 is not limited to a single communication technology; that is, the channel 318 may include several communication links that use a variety of technology. For example, the communication channel 318 can be adapted to provide a path for electrical, optical, and/or electromagnetic communications, etc. As such, the communication channel 318 includes, but is not limited to, one or a combination of the following: electric circuits, electrical conductors such as wires and coaxial cables, fiber optic cables, converters, radio-frequency (rf) waves, the atmosphere, empty space, etc. Furthermore, the communication channel 318 can include intermediate devices such as routers, repeaters, buffers, transmitters, and receivers, for example.

For example, the communication channel 318 includes telephone and computer networks. Furthermore, the communication channel 318 may be capable of accommodating wireless communication such as radio frequency, microwave frequency, infrared communication, etc. Additionally, the communication channel 318 can accommodate satellite communication.

The communication signals transmitted through the communication channel 318 include, but are not limited to, signals as may be required or desired for given communication technology. For example, the signals may be adapted to be used in cellular communication technology such as Time Division Multiple Access (TDMA), Frequency Division Multiple Access (FDMA), Code Division Multiple Access (CDMA), Global System for Mobile Communications (GSM), etc. Both digital and analogue signals can be transmitted through the communication channel 318. These signals may be modulated, encrypted and/or compressed signals as may be desirable for the communication technology.

The server 302 includes a remote server accessible by the navigation device 200 via a wireless channel. The server 302 may include a network server located on a local area network (LAN), wide area network (WAN), virtual private network (VPN), etc.

The server 302 may include a personal computer such as a desktop or laptop computer, and the communication channel 318 may be a cable connected between the personal computer and the navigation device 200. Alternatively, a personal computer may be connected between the navigation device 200 and the server 302 to establish an internet connection between the server 302 and the navigation device 200. Alternatively, a mobile telephone or other handheld device may establish a wireless connection to the internet, for connecting the navigation device 200 to the server 302 via the internet.

The navigation device 200 may be provided with information from the server 302 via information downloads which may be periodically updated upon a user connecting navigation device 200 to the server 302 and/or may be more dynamic upon a more constant or frequent connection being made between the server 302 and navigation device 200 via a wireless mobile connection device and TCP/IP connection for example. For many dynamic calculations, the processor 304 in the server 302 may be used to handle the bulk of the processing needs, however, processor 210 of navigation device 200 can also handle much processing and calculation, oftentimes independent of a connection to a server 302.

As indicated above in FIG. 2, a navigation device 200 includes a processor 210, an input device 220, and a display screen 240. The input device 220 and display screen 240 are integrated into an integrated input and display device to enable both input of information (via direct input, menu selection, etc.) and display of information through a touch panel screen, for example. Such a screen may be a touch input LCD screen, for example, as is well known to those of ordinary skill in the art. Further, the navigation device 200 can also include any additional input device 220 and/or any additional output device 241, such as audio input/output devices for example.

FIGS. 4A and 4B are perspective views of a navigation device 200. As shown in FIG. 4A, the navigation device 200 may be a unit that includes an integrated input and display device 290 (a touch panel screen for example) and the other components of FIG. 2 (including but not limited to internal GPS receiver 250, microprocessor 210, a power supply, memory systems 220, etc.).

The navigation device 200 may sit on an arm 292, which itself may be secured to a vehicle dashboard/window/etc. using a large suction cup 294. This arm 292 is one example of a docking station to which the navigation device 200 can be docked.

As shown in FIG. 4B, the navigation device 200 can be docked or otherwise connected to an arm 292 of the docking station by snap connecting the navigation device 292 to the arm 292 for example (this is only one example, as other known alternatives for connection to a docking station are within the scope of the present application). The navigation device 200 may then be rotatable on the arm 292, as shown by the arrow of FIG. 4B. To release the connection between the navigation device 200 and the docking station, a button on the navigation device 200 may be pressed, for example (this is only one example, as other known alternatives for disconnection to a docking station are within the scope of the present application).

In accordance with the invention, it is desired to make the display of enhanced map information on the display screen of the PND dynamic such that there is more or less enhancement of the information displayed depending on the velocity of the device, and thus the vehicle in which the user may be travelling. Ideally, there is less enhancement as the velocity increases, and above a certain threshold velocity, there is minimal or no enhancement of the map information whatsoever.

However, at lower speeds the display of very detailed and highly enhanced map information can be of great benefit to a user because it can improve his situational awareness and level of perceived familiarity with an otherwise unfamiliar locality. Also, the clarity of a particular navigation instruction can be radically improved by displaying highly detailed map information, as the likelihood of confusion in interpreting navigation instructions, or more precisely the turns a user must make, particularly in densely populated areas, cities, and other areas where there are many possible turns in a very short distance, only one of which is correct.

Advantageously, the invention mimics normal human behaviour on discovering one is lost or in an unfamiliar locality. In such instances, normal human behaviour is to stop and look around, and attempt to re-orientate oneself. Accordingly, when stationary, a maximum amount of detail and enhancement is required in the displayed map information.

The textures on buildings are displayed with higher detail (higher quality) when the speed is low. We standing still the textures are optimal. When driving with higher speed, e.g. >100 km/h, no bitmaps are displayed at all, only building geometry is displayed.

One example implementation is as follows:

Velocity=0-10 km/h: display maximum details in building texture, (e.g. doors, roofs, textures, shadows)

Velocity=10-50 km/h: Display only moderate details (subtle patterns of brick, possibly with subtle edges)

Velocity=+50 km/h: no details Oust one color for a building block, no shadow)

It is worth mentioning that the omission of map information as the speed of the device increases is a known feature already present in the applicant's current products. Accordingly, for the avoidance of doubt, this invention is concerned with the extent to which map information, or one or more specific features available within the enhanced map information, is enhanced, as opposed to the extent to which the quality of the standard, non-enhanced map information is reduced, depending on the speed of travel of the device.

What is claimed is:

1. A method of displaying enhanced map information on a personal navigation device, the method comprising the steps of:
determining a velocity of the personal navigation device;
displaying map information on a display screen of the personal navigation device, said map information being at least one of continually and periodically refreshed to take account of a displacement of said device brought about by said device's velocity, wherein an extent to which said map information displayed is enhanced to include one or more enhanced features is dependent on said velocity.

2. The method according to claim 1, further comprising the step of choosing said enhanced features from a group comprising at least one of building textures, digitized photographic images of building facades, landscapes, discrete areas of land and buildings, vistas, patterns representative of land use, street lights, electricity pylons, tram rails, train rails, zebra crossings and traffic signs, types of road surfaces or patterns indicative thereof, road markings, traffic lights, landmarks in the distance or digitized photographs thereof, cities in the distance or digitized photographs thereof, animated pattern, bicycle lanes, bus lanes, graphically or textually represented commercial, agricultural, tourist or traffic information, and enhanced POI icons.

3. The method according to claim 1, wherein said enhancement of said map information displayed or said one or more particular features included in the enhanced map information, is gradual or progressive dependent on said velocity such that different velocities can result in different levels of enhancement.

4. The method according to claim 3, wherein said map information displayed or one or more of said features included as part of said enhanced map information is fully enhanced when said velocity is below a first threshold.

5. The method according to claim 1, wherein said map information displayed or one or more of said features included as part of said enhanced map information is partially enhanced when said velocity is between a first threshold and a second threshold.

6. The method according to claim 1, wherein said map information, or one or more of said features included as part of the enhanced map information, is enhanced to a lesser or minimal degree, or not enhanced at all, when said velocity is above a third threshold.

7. A computer program comprising computer program code means adapted to perform all the steps of any of claims 1 when run on a computer.

8. A computer program as claimed in claim 7 when embodied on or in a computer readable medium.

9. A PND adapted to implement the method of claim 1.

10. A navigation system adapted to implement the method of claim 1.

11. A PND programmed with the computer program of claim 7.

12. A navigation system programmed with the computer program of claim 7.
